(19) United States
(12) Patent Application Publication
(10) Pub. No.: US 2024/0142314 A1
(43) Pub. Date: May 2, 2024

(54) TEMPERATURE MEASUREMENT SYSTEM AND METHOD

(71) Applicant: Purdue Research Foundation, West Lafayette, IN (US)

(72) Inventors: Roberto Felix Nares Alcala, West Lafayette, IN (US); Guillermo Paniagua-Perez, West Lafayette, IN (US); Lakshya Bhatnagar, West Lafayette, IN (US)

(73) Assignee: Purdue Research Foundation, West Lafayette, IN (US)

(21) Appl. No.: 18/383,989

(22) Filed: Oct. 26, 2023

Related U.S. Application Data
(60) Provisional application No. 63/419,922, filed on Oct. 27, 2022.

(51) Int. Cl. G01K 7/02; G06F 30/28

(52) U.S. Cl. CPC G01K 7/021; G06F 30/28

(57) ABSTRACT

The temperature measurement system includes a thermocouple probe, a non-transitory computer-readable storage medium storing processor-executable instructions, and a processor. The processor-executable instructions are configured to enable to processor to form a model of the thermocouple probe, perform several computational fluid dynamic (CFD) analyses of the thermocouple probe using a predetermined Reynolds number, output a first temperature (T_{1CFD}) and a second temperature (T_{2CFD}) at the junctions for each simulation, apply a linear regression between the T_{1CFD} and the T_{2CFD}, output a slope from the linear regression, and output a corrected gas temperature with at least one algorithm.

### CROSS REFERENCE TO RELATED APPLICATIONS

This application claims the priority benefit of U.S. Provisional Patent application No. 63/419,922, filed Oct. 27, 2022, the contents of which is incorporated herein by reference in its entirety.

### FIELD

The disclosure generally relates to temperature measurement tools and, more particularly, to temperature measurement thermocouple systems.

### INTRODUCTION

This section provides background information related to the present disclosure, which is not necessarily prior art.

Thermocouples are devices used to measure temperature and are one of the more versatile temperature sensors available. These temperature sensors or transducers are generally rugged, relatively inexpensive, and may be constructed of various metals. Thermocouples may be used to measure a relatively wide range of temperatures (e.g., −200° C. to 2600° C.) in a variety of applications and environments. In general, thermocouples rely on the principle that a voltage potential occurs when there is a temperature gradient along the length of a conductor.

Known thermocouple devices are formed by joining two conductors or wires of dissimilar metals to form a junction of the two wires called a measuring junction (or sensing junction). Although almost any two types of metal can be used to make the thermocouple wires, a number of standard types are used because they possess predictable output voltages and can handle large temperature gradients. The several types of thermocouples available may be designated by capital letters that indicate their composition according to American National Standards Institute (ANSI) conventions. For example, a J-type thermocouple has one iron conductor and one constantan (copper-nickel alloy) conductor.

The thermocouple measuring junction may be encased in a sensor probe, for example, with the probe positioned at the point of temperature measurement (i.e., at the temperature source). In principle, as the temperature of the measuring junction changes with the temperature source, a temperature gradient is formed (along the wires) between the measuring junction and the opposite free ends of the two wires. Advantageously, a predictable thermoelectric voltage is generated as a function of this temperature gradient. By taking into account the composition of the two dissimilar metal wires, this generated thermoelectric voltage (sometimes called the “Seebeck” voltage) can be related to the temperature gradient along the wires. This temperature gradient is summed with a reference or “cold” junction temperature to give the temperature of the source being measured.

However, three main factors inhibit the precise accuracy of known thermocouple devices, namely, radiation error, velocity error, and conduction error. Radiation error can be negligible using a protective shield around the probe for temperatures lower than 800K. The velocity error can be corrected using dedicated experimental calibrations to measure the recovery factor. However, the conduction error, remains an unresolved challenge in the aerospace and power-energy community.

The gas turbine industry invests over a billion dollars in new engine development programs. In those engine development programs, the engine's efficiency plays a critical role, enabling winning or losing a contract. In order to ensure accurate efficiency measurements, temperature accuracies better than 0.5 K are necessary for turbomachinery component testing. However, known thermocouple devices have uncertainties of over 5 K associated to the conduction error. The conduction error arises from the large temperature difference between the hot junction of the thermocouple and the varying temperature of the shield/support during the test or the day. This heat conduction causes the hot junction to reach a different temperature than the total temperature of the gas.

To minimize the conduction error, known methods include increasing the wire's length or decreasing the wire's diameter. However, this is not a practical solution in high-speed flows, due to the structural constraints, which would lead to the breakage of the wires.

Other more complex solutions have been tested, including a heat source at the support. This design reduces the temperature difference between junction and probe by actively heating the support with an electric resistance, and another thermocouple is used to measure the support temperature. This complex design unfortunately is costly to manufacture, is difficult to estimate the necessary heat intensity, and provides highly uncertain results.

Another known solution is acquiring a temperature measurement at a support of the probe. A numerical correction of conduction error is performed employing this design. The numerical corrections for temperature measurement at the support is known to have highly uncertain results due to the variance in estimations.

For instance, type T thermocouples (copper-constantan) have very high thermal conductivity because of copper. Known two wire thermocouples have been applied successfully to improve time response, however, conduction error correction is only available for steady conditions. Others in the field have tried to correct conduction error with a single wire thermocouple. To do this, the temperature of the shield/probe is needed. Unfortunately, it is difficult to estimate this temperature, which may change depending on the conditions of the experiment. Furthermore, small errors in the estimation of the convective heat transfer coefficient will cause large errors in the correction, therefore making the correction invalid.

In ever-increasing demanding applications in precision temperature measurement, and with equally demanding desires to reduce costs, the presence of conduction error can be problematic. Accordingly, there is a continuing need for a temperature measurement system that may efficiently and accurately account for and correct the conduction error in temperature measurement thermocouple applications. Desirably, the temperature measurement system may be easily utilized with known thermocouple systems.

### SUMMARY

In concordance with the instant disclosure, the temperature measurement system may efficiently and accurately account for and militate against a conduction error in temperature measurement of thermocouple applications. Desirably, the temperature measurement system may be easily utilized with known thermocouple probes.

The temperature measurement system includes a thermocouple probe, a non-transitory computer-readable storage medium storing processor-executable instructions, and a processor. The storage medium may be communicatively coupled to the thermocouple probe. The processor may be electrically coupled to the storage medium. The processor-executable instructions are configured to enable the processor to form a three-dimensional model of the thermocouple probe, perform a computational fluid dynamic (CFD) analysis of the thermocouple probe at the correct range of Reynolds numbers, output a first temperature (T_{1CFD}) and a second temperature (T_{2CFD}) at the junctions for each simulation, apply a linear regression between the cloud of points T_{1 CFD} and T_{2 CFD}, output a slope from the linear regression, and identify a corrected gas temperature with an algorithm. In a specific example, the processor-executable instructions are configured to enable the processor to perform several computational fluid dynamic analyses.

In certain circumstances, the temperature measurement system may include a non-transitory computer-readable storage medium storing executable instructions that, when executed by a processor, facilitate performance of operations. These operations may include, but are not limited to, the following functions. Forming a three-dimensional model of a thermocouple probe. Performing several CFD analyses of the thermocouple probe, at the correct range of Reynolds numbers. Outputting a first temperature (T_{1CFD}) and a second temperature (T_{2CFD}) at the junctions for each simulation. Applying a linear regression between the cloud of points T_{1 CFD} and T_{2 CFD}. Outputting a slope from the linear regression. Outputting a corrected gas temperature utilizing at least one algorithm.

Various ways of using the temperature measurement system are provided. For instance, a method may include a step of providing a thermocouple probe, a non-transitory computer-readable storage medium storing processor-executable instructions, and a processor. A three-dimensional model of a thermocouple probe may be formed, via the processor. Then, several computational fluid dynamic (CFD) analyses of the thermocouple probe may be performed at the correct range of Reynolds numbers. Next, the method may include a step of outputting a first temperature (T_{1CFD}) and a second temperature (T_{2CFD}) at the junctions for each simulation. Linear regression may be applied between the cloud of points T_{1 CFD} and T_{2 CFD}. Afterward, the method may include a step of outputting a slope from the linear regression. Then, the computer may output a corrected gas temperature utilizing at least one algorithm.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a box diagram of a temperature measurement system, according to one embodiment of the present disclosure;

FIG. 2 is a front perspective view of a thermocouple probe, further depicting a first wire and a second wire disposed on stems, according to one embodiment of the present disclosure;

FIG. 3 is a front perspective view of a thermocouple probe, further depicting the first wire and the second wire disposed within a shield, according to one embodiment of the present disclosure;

FIG. 4 is a computer-generated representation of a computational fluid dynamic analysis of a thermocouple probe, according to one embodiment of the present disclosure;

FIG. 5 is a linear regression model for calculating a corrected temperature based on a first temperature and a second temperature, according to one embodiment of the present disclosure;

FIG. 6 is a bar graph of a plurality of computational fluid dynamic analyses, further depicting a slope being determined based on a total temperature and a plurality of support temperatures, according to one embodiment of the present disclosure;

FIG. 7 is a front perspective view of a thermocouple probe, further depicting the first wire and the second wire disposed within a shield, according to one embodiment of the present disclosure;

FIG. 8 is an enlarged front perspective view of the thermocouple probe, as shown in FIG. 7, further depicting the first wire and the second wire disposed within a shield, according to one embodiment of the present disclosure;

FIG. 9 is a cross-sectional view of the first and second wires, as shown in FIGS. 7-8, further depicting the first wire having a smaller diameter than the second wire, according to one embodiment of the present disclosure;

FIG. 10 is a line graph of a regression comparing the first temperature with the total temperature and the plurality of support temperatures, further depicting the different simulations being run at different isotherm temperatures, according to one embodiment of the present disclosure;

FIG. 11 is a line graph of a regression comparing the first temperature and the second temperature with the total temperature and the plurality of support temperatures, further depicting the different simulations being run at different isotherm temperatures, according to one embodiment of the present disclosure;

FIG. 12 is a front perspective view of a thermocouple probe, further depicting the first wire and the second wire disposed within a shield, further depicting the static temperature of the first wire and the second wire, according to one embodiment of the present disclosure;

FIG. 13 is a line graph of a gradient comparing the first temperature and the second temperature, further depicting the determination of the slope being around 2.5, according to one embodiment of the present disclosure;

FIG. 14 is a table illustrating the boundary condition for the support temperature for which the CFD conjugate analysis was run to obtain the regression fit between the two junction temperatures, according to one embodiment of the present disclosure.

FIG. 15 is a table outlining the results of the regression model, shown in FIG. 12, further depicting an uncertainty associated with the regression of less than 0.1K and a max error, under the tested flow conditions, of 0.03K, according to one embodiment of the present disclosure;

FIG. 16 is an algorithm for calculating the uncertainty of the temperature correction, according to one embodiment of the present disclosure;

FIG. 17 is a table outlining the error propagation for different sources of error, further depicting the most critical error sources being the length of the first wire and the second wire, according to one embodiment of the present disclosure;

FIG. 18 is a line graph illustrating the temperature for hot gun flow under low-speed conditions, according to one embodiment of the present disclosure;

FIG. 19 is a line graph illustrating the temperature for high-speed flow at STARR, according to one embodiment of the present disclosure;

FIG. 20 is a schematic diagram of the temperature measurement system, further depicting the system having a communication interface, an input interface, a user interface, and a system circuitry, wherein the system circuitry may include a processor and a memory, according to one embodiment of the present disclosure; and

FIG. 21 is a flowchart depicting a method for using a temperature measurement system configured to militate against a conduction error, according to one embodiment of the present disclosure.

### DETAILED DESCRIPTION

The following description of the technology is merely exemplary in nature of the subject matter, manufacture, and use of one or more inventions and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the FIG. is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

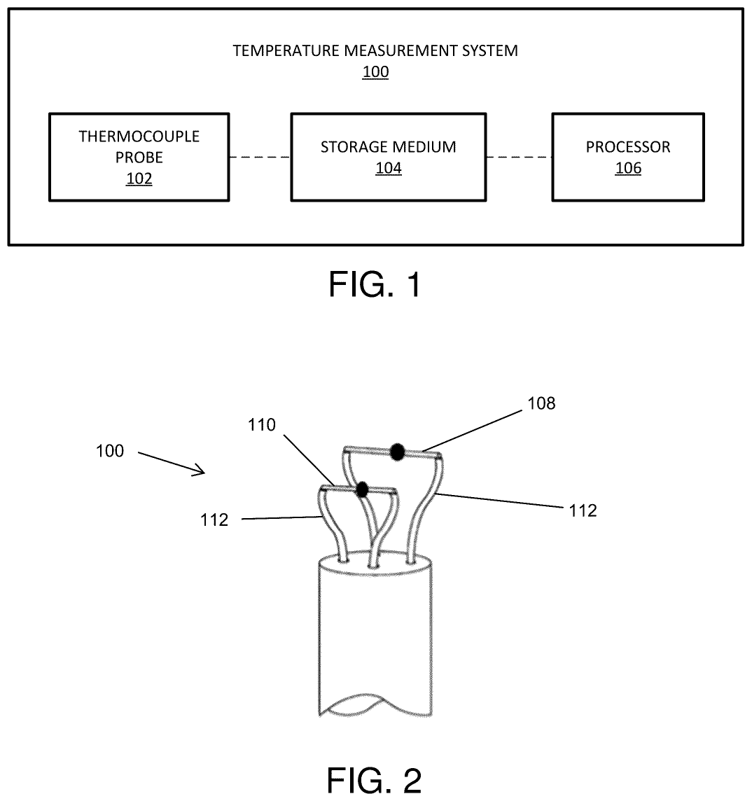

As shown in FIG. 1, the temperature measurement system 100 includes a thermocouple probe 102, a non-transitory computer-readable storage medium and/or memory 104 storing processor-executable instructions, and a processor 106. The storage medium and/or memory 104 may be communicatively coupled to the thermocouple probe 102. The processor may be electrically coupled to the storage medium. The processor-executable instructions enable the processor to form a three-dimensional model of the thermocouple probe 102, execute several CFD analyses of the thermocouple probe 102, at the correct range of Reynolds, output a first temperature (T_{1CFD}) and a second temperature (T_{2CFD}) at the junctions for each simulation, apply a linear regression between the cloud of points T_{1 CFD} and T_{2 CFD}, output a slope from the linear regression, and identify a corrected gas temperature with an algorithm.

In a specific example, the storage medium and the processor may be electrically coupled to the thermocouple probe 102, thus providing the temperature measurement system 100 as a single device.

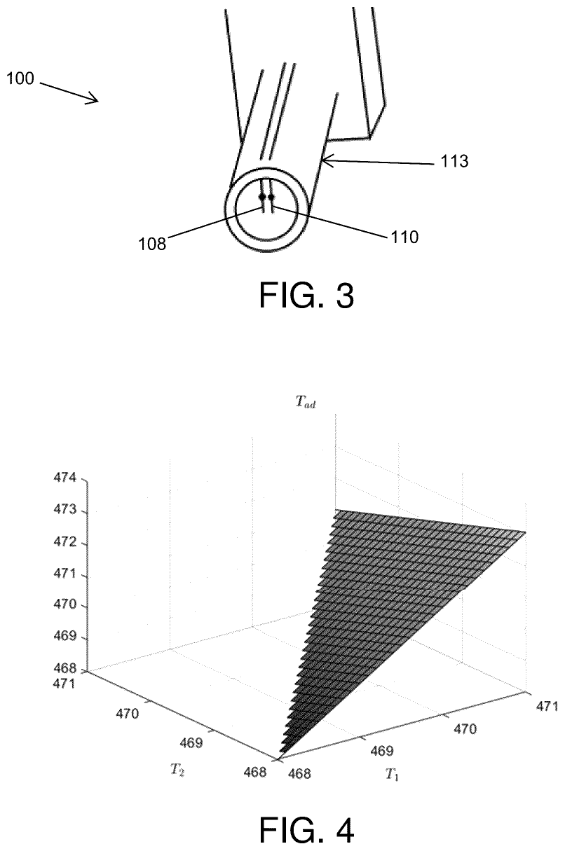

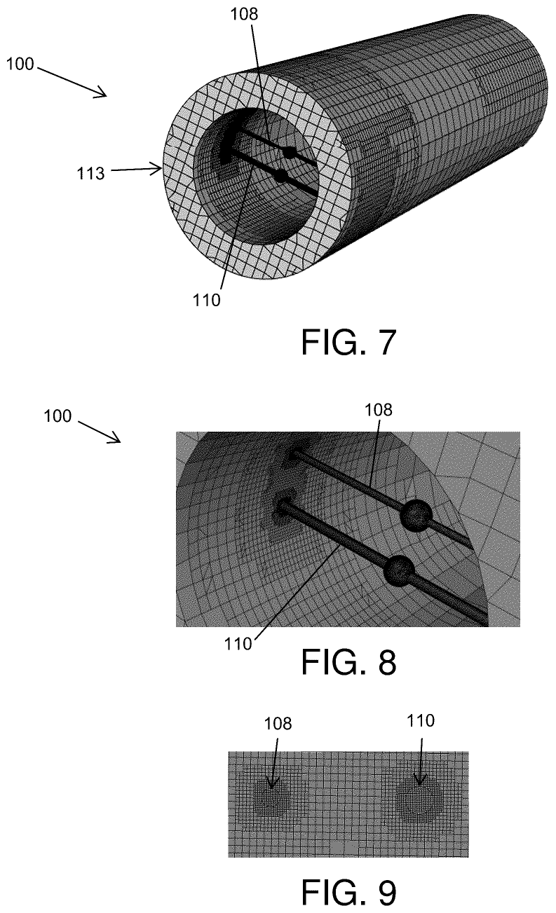

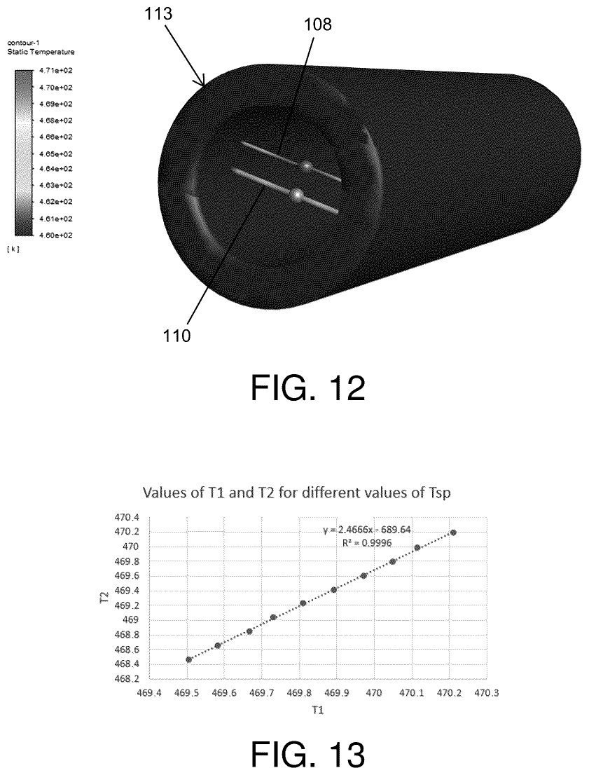

In certain circumstances, the thermocouple probe 102 may be provided in various forms and manufactured with a variety of materials. For instance, the thermocouple probe 102 may include a first wire 108 having a first diameter D1 and a second wire 110 having a second diameter D2, and the first diameter D1 is less than the second diameter D2. Advantageously, where the first diameter D1 is less than the second diameter D2, the thermocouple probe 102 may deliver two different temperatures values for inputting and comparing in the at least one algorithm. For instance, the first diameter D1 may be around 50 micrometers and the second diameter D2 may be around 75 micrometers. The first wire 108 and the second wire 110 may have substantially similar lengths. For instance, the first and second wires 108,110 may be around two millimeters. The material for the first and second wires 108,110 may correspond to a type K thermocouple (chromel-alumel). Other materials for the first and second wires 108,110 may include chromel-constantan, iron-constantan, nicrosil-nisil, and platinum (with rhodium)-platinum. In a specific example, the thermocouple probe 102 may be provided with the first wire 108 and the second wire 110 disposed on supports/stems 112, as shown in FIG. 2. In another specific example, the first and second wires 108,110 may be at least partially protected by a shield 113, or otherwise provided as a shield-wires-junction set, as shown in FIGS. 3, 7-9, and 12. The materials for the shield 113 and a support/stem 112 may both be steel. As a non-limiting example, the dimensions of the first and second wires 108,110 may be around the dimensions provided in Table 1 below. One skilled in the art may select other suitable configurations and/or materials to form the thermocouple probe 102.

TABLE 1

| | Wire1 | Wire2 |
|---|---|---|
| l_{w}[mm] | 2 | 2 |
| d_{w}[mm] | 0.050 | 0.075 |
| d₁[mm] | 0.1 | 0.1 |
| l_{w}/d_{w} | 40 | 26.67 |

In certain circumstances, the at least one algorithm includes:

$${T}_{0 , corrected} = {T}_{1 , experiment} + \frac{{T}_{1 , experiment} - {T}_{2 , experiment}}{m - 1}$$

Alternatively, the algorithm may also correct for thermocouple thermal inertia by being provided as:

$${T}_{0 corrected} = {T}_{1 m e a s u r e d} + \frac{{T}_{1 m e a s u r e d} - {T}_{2 m e a s u r e d}}{m - 1} + {T}_{1}^{′} + \frac{{T}_{1}^{′} - {T}_{2}^{′}}{m - 1}$$

The measured temperature of the junctions, T_{measured} can be decomposed as the steady state temperature and transient lag of temperature as:

T_{measured}=T_{steadystate}−T′

The algorithm includes one decomposition of transient temperature correction as one first order response as:

T′=C₁e^{-α}^{₁}^{(λ}^{₁}^{+m}^{₁}^{)t}

Where the parameters α₁, λ₁, m₁ are based on the probe design and can be estimated through computational fluid dynamic analysis and/or a reduced order model.

In certain circumstances, the computational fluid dynamic analysis is performed with a plurality of support temperatures (Tₛᵤₚₚₒᵣₜ) and a fixed inlet gas total temperatures (T₀). In a specific example, the T₁ and the T₂ may be outputted according to:
T_{1,CFD1} and T_{2,CFD1} for the first case of (T_{support,1}) and (T_{0,1})
T_{1,CFD2} and T_{2,CFD2} for the second case of (T_{support,2}) and (T_{0,2})
T_{1,CFD3} and T_{2,CFD3} for the third case of (T_{support,3}) and (T_{0,3})
etc. . . .

In certain circumstances, the temperature measurement system 100 may be provided in a form that may be readily used with an existing thermocouple probe 102. For instance, the temperature measurement system 100 may include a non-transitory computer-readable storage medium and/or memory 104 storing executable instructions that, when executed by a processor, facilitate performance of operations. These operations may include, but are not limited to, the following functions. Forming a three-dimensional model of a thermocouple probe 102. Performing several CFD analyses of the thermocouple probe 102, at the correct range of Reynolds numbers. Outputting a first temperature (T_{1CFD}) and a second temperature (T_{2CFD}) at the junctions for each simulation. Applying a linear regression between the cloud of points T_{1 CFD} and T_{2 CFD}. Outputting a slope from the linear regression. Outputting a corrected gas temperature utilizing at least one algorithm.

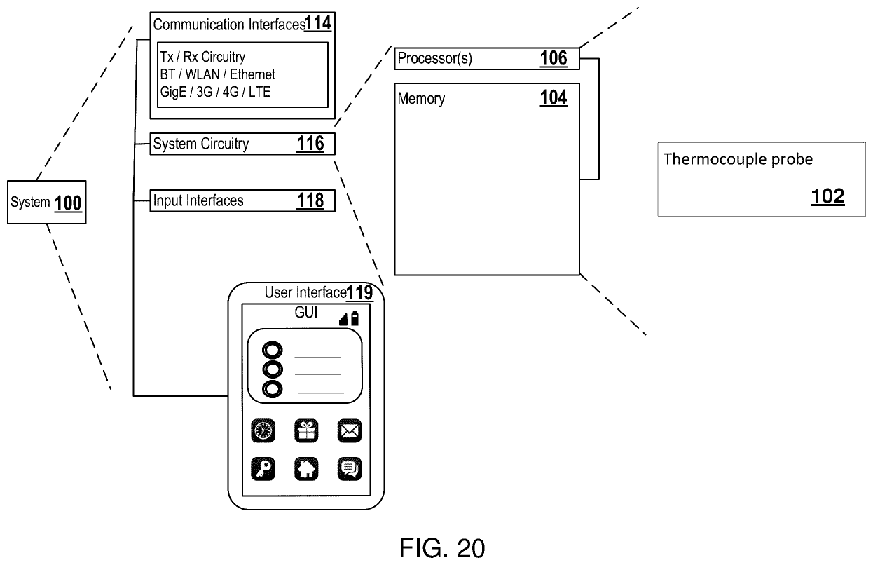

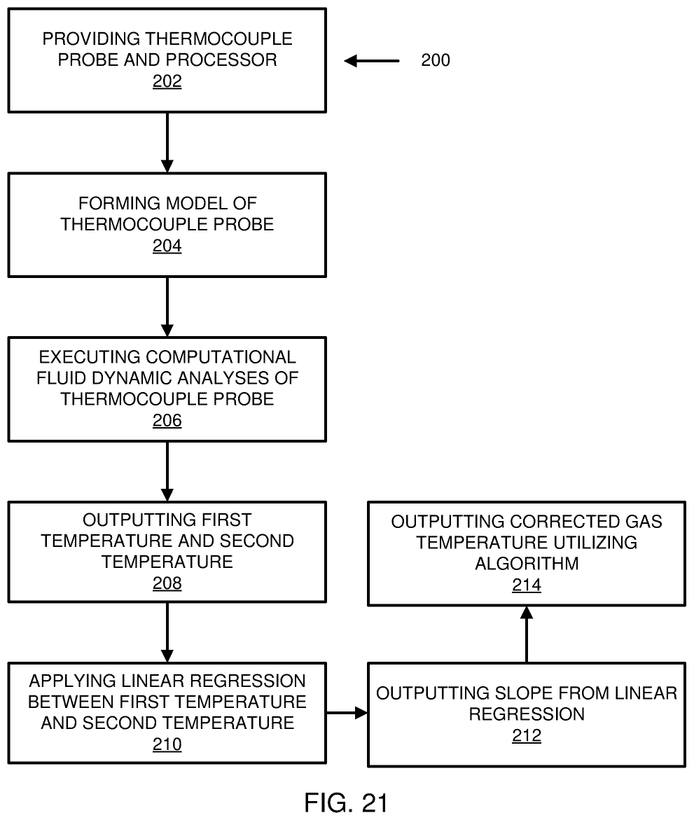

As shown in FIG. 20, the temperature measurement system 100 may further include a communication interface 114, a system circuitry 116, and/or an input interface 118. The system circuitry 116 may include the processor 106 or multiple processors. The processor 106 or multiple processors execute the steps to form a model of a thermocouple probe 102, execute computational fluid dynamic (CFD) analyses of the thermocouple probe 102 using a predetermined Reynolds number; output a first temperature (T_{1CFD}) and a second temperature (T_{2CFD}) at a junction for each simulation, apply a linear regression between the T_{1CFD} and the T_{2CFD}, output a slope from the linear regression, and output a corrected gas temperature with at least one algorithm. Alternatively, or in addition, the system circuitry 116 may include the memory 104.

The processor 106 may be in communication with the memory 104. In some examples, as shown in FIG. 20, the processor 106 may also be in communication with additional elements, such as the communication interfaces 114, the input interfaces 118, and/or the user interface 119. Examples of the processor 106 may include a general processor, a central processing unit, logical CPUs/arrays, a microcontroller, a server, an application specific integrated circuit (ASIC), a digital signal processor, a field programmable gate array (FPGA), and/or a digital circuit, analog circuit, or some combination thereof.

The processor 106 may be one or more devices operable to execute logic. The logic may include computer executable instructions or computer code stored in the memory 104 or in other memory that when executed by the processor 106, cause the processor 106 to perform the operations of a thermocouple probe 102. The computer code may include instructions executable with the processor 106.

The memory 104 may be any device for storing and retrieving data or any combination thereof. The memory 104 may include non-volatile and/or volatile memory, such as a random-access memory (RAM), a read-only memory (ROM), an erasable programmable read-only memory (EPROM), or flash memory. Alternatively or in addition, the memory 104 may include an optical, magnetic (hard-drive), solid-state drive or any other form of data storage device. The memory 104 may be included in any component or sub-component of the system 100 described herein.

The user interface 119 may include any interface for displaying graphical information. The system circuitry 116 and/or the communications interface(s) 114 may communicate signals or commands to the user interface 119 that cause the user interface to display graphical information. Alternatively or in addition, the user interface 119 may be remote to the system 100 and the system circuitry 116 and/or communication interface(s) 114 may communicate instructions, such as HTML, to the user interface to cause the user interface to display, compile, and/or render information content. In some examples, the content displayed by the user interface 119 may be interactive or responsive to user input. For example, the user interface 119 may communicate signals, messages, and/or information back to the communications interface 114 or system circuitry 116.

The system 100 may be implemented in many different ways. In some examples, the system 100 may be implemented with one or more logical components. For example, the logical components of the system 100 may be hardware or a combination of hardware and software. In some examples, each logic component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each component may include memory hardware, such as a portion of the memory 104, for example, that comprises instructions executable with the processor 106 or other processor to implement one or more of the features of the logical components. When any one of the logical components includes the portion of the memory that comprises instructions executable with the processor 106, the component may or may not include the processor 106. In some examples, each logical component may just be the portion of the memory 104 or other physical memory that comprises instructions executable with the processor 106, or other processor(s), to implement the features of the corresponding component without the component including any other hardware. Because each component includes at least some hardware even when the included hardware comprises software, each component may be interchangeably referred to as a hardware component.

Some features are shown stored in a computer readable storage medium (for example, as logic implemented as computer executable instructions or as data structures in memory). All or part of the system 100 and its logic and data structures may be stored on, distributed across, or read from one or more types of computer readable storage media. Examples of the computer readable storage medium may include a hard disk, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device.

The processing capability of the system 100 may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL).

All of the discussion, regardless of the particular implementation described, is illustrative in nature, rather than limiting. For example, although selected aspects, features, or components of the implementations are depicted as being stored in memory(s), all or part of the system or systems may be stored on, distributed across, or read from other computer readable storage media, for example, secondary storage devices such as hard disks and flash memory drives. Moreover, the various logical units, circuitry and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor 106 or processing strategy and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transfer through a computer network or over telephone lines. In yet other examples, the logic or instructions are stored within a given computer and/or central processing unit (“CPU”).

Furthermore, although specific components are described above, methods, systems, and articles of manufacture described herein may include additional, fewer, or different components. For example, a processor 106 may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same apparatus executing a same program or different programs. The components may be resident on separate hardware, such as separate removable circuit boards, or share common hardware, such as a same memory and processor for implementing instructions from the memory. Programs may be parts of a single program, separate programs, or distributed across several memories and processors.

Various ways of using the temperature measurement system 100 are provided. For instance, as shown in FIG. 21, a method may include a step of providing a thermocouple probe 102, a non-transitory computer-readable storage medium storing processor-executable instructions, and a processor. A three-dimensional model of a thermocouple probe 102 may be formed, via the processor. Then, several computational fluid dynamic (CFD) analyses of the thermocouple probe 102 may be performed using a predetermined Reynolds number. Next, the method may include a step of outputting a first temperature (T_{1CFD}) and a second temperature (T_{2CFD}) at the junctions for each simulation. A linear regression may be applied between the T_{1CFD} and the T_{2CFD}. Afterwards, the method may include a step of outputting a slope from the linear regression. Then, the computer may output a corrected gas temperature utilizing at least one algorithm.

In a specific example, as shown in FIG. 4, the correct temperature of the gas (T_{ad}) may be found by utilizing a regression analysis according to the following formula:

T_{ad}=f(T₁,T₂)

The computational fluid dynamic analysis may then be used to evaluate the required coefficient b, which is dependent on the predetermined Reynolds number. The predetermined Reynolds number may be obtained through the formula below, where the flow speed is considered outside the shield.

$$R e = \frac{ρ u L}{μ} \qquad \begin{matrix}R e = reynolds number \\ ρ = density of the fluid \\ u = flow speed \\ L = characteristics linear dimension \\ μ = dynamic viscosity of the fluid\end{matrix}$$

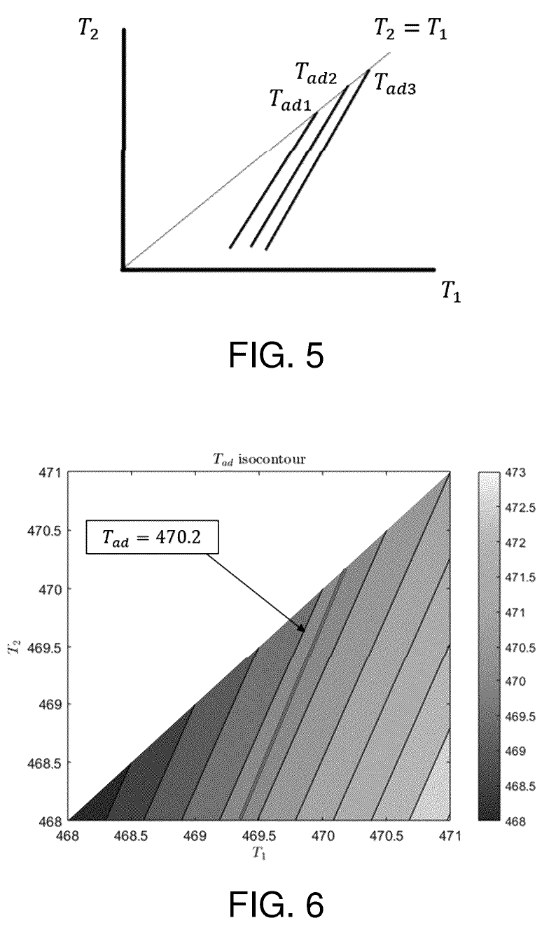

As shown in FIG. 5, a linear fit is found between T₁ and T₂. This linear approximation may be defined as the slope (m). As shown in FIG. 6, m may be obtained by running several CFD simulations at the predetermined Reynolds number for a given total temperature (T₀). With several support temperatures (Tₛₚ). m may then be used in the following algorithm to determine the T_{ad}.

$${T}_{ad} = {T}_{1} + \frac{{T}_{1} - {T}_{2}}{m - 1}$$

Alternatively, the algorithm may also correct for thermocouple thermal inertia by being provided as:

$${T}_{0 corrected} = {T}_{1 m e a s u r e d} + \frac{{T}_{1 m e a s u r e d} - {T}_{2 m e a s u r e d}}{m - 1} + {T}_{1}^{′} + \frac{{T}_{1}^{′} - {T}_{2}^{′}}{m - 1}$$

In a specific example, the computational fluid dynamic analysis may be performed with a plurality of support temperatures (Tₛᵤₚₚₒᵣₜ) and a fixed inlet gas total temperature (T₀).

### Example

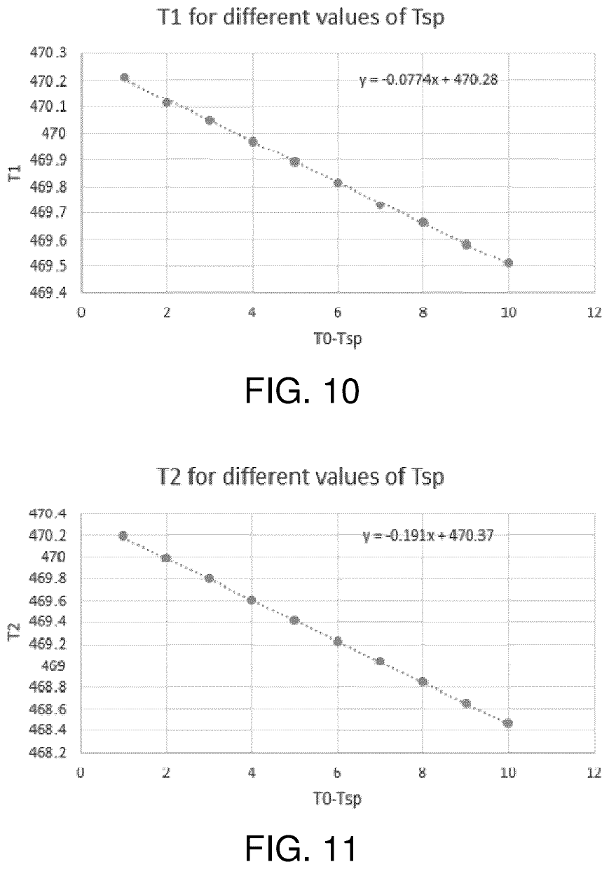

As shown in FIGS. 10-12, the present disclosure was tested by performing a regression at different simulations. For instance, with continued reference to FIGS. 10-11, the different simulations were run with different isotherm temperatures for the shield, from 1K lower than the total temperature to 10K lower (10 simulations in total). After the regression, the gradient of the plot T2−T1 was obtained, which is almost 2.5, as shown in FIG. 13. From the gradient m, the parameter b for the correction was obtained.

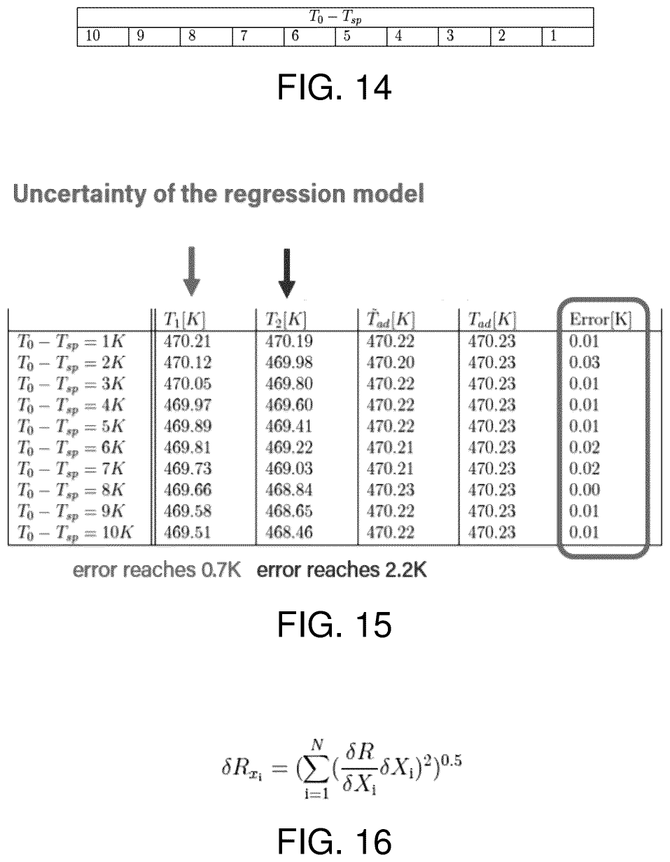

A visualization of the regression model is provided in FIGS. 14-15. Provided as a non-limiting example, the uncertainty associated with the regression was less than 0.1K for the tested flow conditions.

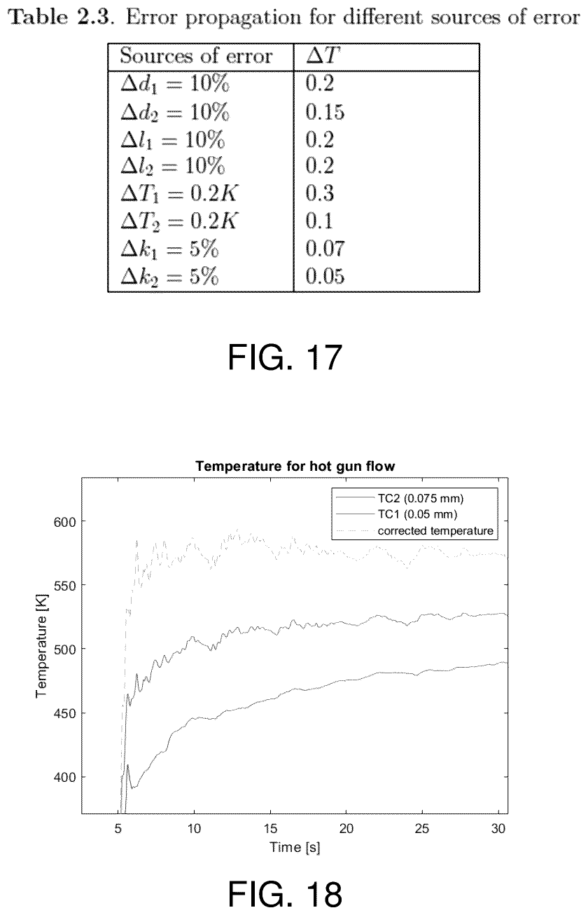

An uncertainty analysis, using the algorithm shown in FIG. 16, was performed based on the different sources of uncertainty such as the diameter of the wires, length, and the wires' thermal conductivity. As shown in FIG. 17, the most critical uncertainties of T₁ and T₂ may be attributed to the lengths of the first and second wires 108,110.

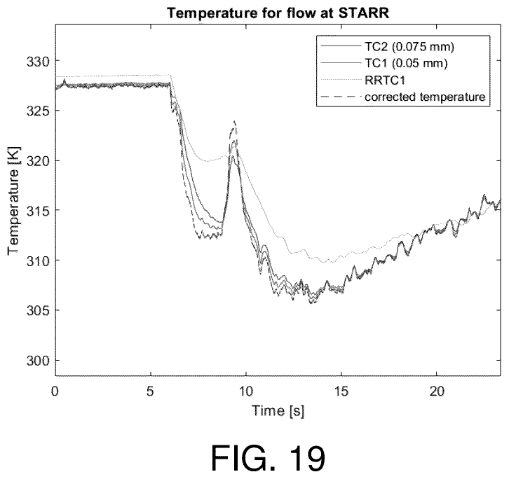

As a non-limiting experimental demonstration, a low-speed flow test and a high-speed flow test were performed using a two-stage turbine module (STARR) from Purdue University, as shown in FIGS. 18-19. The Mach number was around 0.2. The first stage of the flow has several transients in temperature, followed by a quasi-steady flow. Regarding the steady conduction error, it can be seen that it is smaller than the temperature fluctuations of the flow. However, the transients, primarily between five and ten seconds, show a significant conduction error that the correction technique of the present disclosure may successfully predict. The tested conduction error reaches almost 5 K in the case of TC2. To note, velocity error was found to be lower than 0.2 K for the tested flow conditions. Without being bound to any particular theory, this is believed to be due to the probe being shielded. Without the probe being shielded, it is believed this velocity error would not be as negligible.

Advantageously, the temperature measurement system 100 may efficiently and accurately account for and militate against a conduction error in temperature measurement of thermocouple applications. Desirably, the temperature measurement system 100 may be easily utilized with known thermocouple probes.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. A non-transitory computer-readable storage medium storing executable instructions that, when executed by a processor, facilitate performance of operations, comprising:
form a model of;
execute computational fluid dynamic (CFD) analyses of the thermocouple probe using a predetermined Reynolds number;
output a first temperature (T_{1CFD}) and a second temperature (T_{2CFD}) at a junction for each simulation;
apply a linear regression between the T_{1CFD} and the T_{2CFD};
output a slope from the linear regression; and
output a corrected gas temperature with at least one algorithm.

2. The non-transitory computer-readable storage medium storing executable instructions of claim 1, wherein the at least one algorithm includes:
$${T}_{0 , corrected} = {T}_{1 , experiment} + \frac{{T}_{1 , experiment} - {T}_{2 , experiment}}{m - 1}$$

3. The non-transitory computer-readable storage medium storing executable instructions of claim 2, wherein the at least one algorithm includes:
$${T}_{0 corrected} = {T}_{1 , experiment} + \frac{{T}_{1 experiment} - {T}_{2 experiment}}{m - 1} + {T}_{1}^{′} + \frac{{T}_{1}^{′} - {T}_{2}^{′}}{m - 1}$$

4. The non-transitory computer-readable storage medium storing executable instructions of claim 1, wherein the computational fluid dynamic analysis is performed with a plurality of support temperatures (Tₛᵤₚₚₒᵣₜ) and a fixed inlet gas total temperature (T₀).

5. The non-transitory computer-readable storage medium storing executable instructions of claim 2, wherein the T₁ and the T₂ are outputted according to:
T_{1,CFD1} and T_{2,CFD1} for a first case of (T_{support,1}) and (T_{0,1})
T_{1,CFD2} and T_{2,CFD2} for a second case of (T_{support,2}) and (T_{0,2}), etc.

6. The non-transitory computer-readable storage medium storing executable instructions of claim 1, wherein the computational fluid dynamic analysis is one of a conjugate fluid-solid heat transfer analysis and a reduced order model.

7. The non-transitory computer-readable storage medium storing executable instructions of claim 1, wherein the model is one of a three-dimensional model and a reduced order model.

8. A temperature measurement system, the system comprising:
a thermocouple probe;
a non-transitory computer-readable storage medium storing processor-executable instructions, the storage medium communicatively coupled to the thermocouple probe; and
a processor electrically coupled to the storage medium;
wherein the processor-executable instructions are executed to:
form a model of the thermocouple probe;
execute computational fluid dynamic (CFD) analyses of the thermocouple probe using a predetermined Reynolds number;
output a first temperature (T_{1CFD}) and a second temperature (T_{2CFD}) at a junction for each simulation;
apply a linear regression between the T_{1CFD} and the T_{2CFD};
output a slope from the linear regression; and
output a corrected gas temperature with at least one algorithm.

9. The temperature measurement system of claim 8, wherein the at least one algorithm includes:
$${T}_{0 , corrected} = {T}_{1 , experiment} + \frac{{T}_{1 , experiment} - {T}_{2 , experiment}}{m - 1}$$

10. The temperature measurement system of claim 9, wherein the at least one algorithm includes:
$${T}_{0 corrected} = {T}_{1 , experiment} + \frac{{T}_{1 experiment} - {T}_{2 experiment}}{m - 1} + {T}_{1}^{′} + \frac{{T}_{1}^{′} - {T}_{2}^{′}}{m - 1}$$

11. The temperature measurement system of claim 9, wherein the computational fluid dynamic analysis is performed with a plurality of support temperatures (Tₛᵤₚₚₒᵣₜ) and a fixed inlet gas total temperature (T₀).

12. The temperature measurement system of claim 9, wherein the T₁ and the T₂ are outputted according to:
T_{1,CFD1} and T_{2,CFD1} for a first case of (T_{support,1}) and (T_{0,1})
T_{1,CFD2} and T_{2,CFD2} for a second case of (T_{support,2}) and (T_{0,2}), etc.

13. The temperature measurement system of claim 8, wherein the model is a three-dimensional model.

14. The temperature measurement system of claim 8, wherein the model is a reduced order model.

15. The temperature measurement system of claim 8, wherein the storage medium and the processor are electrically coupled to the thermocouple probe, thus providing the temperature measurement system as a single device.

16. The temperature measurement system of claim 8, wherein the thermocouple probe includes a first wire having a first diameter and a second wire having a second diameter, and the first diameter is less than the second diameter.

17. The temperature measurement system of claim 16, wherein at least one of the first wire and the second wire are manufactured from one of chromel-alumel, chromel-constantan, iron-constantan, nicrosil-nisil, and platinum/rhodium-platinum.

18. A method of using a temperature measurement system configured to militate against a conduction error, the method comprising the steps of:
providing a thermocouple probe, a non-transitory computer-readable storage medium storing processor-executable instructions, and a processor;
forming, via the processor, a model of a thermocouple probe;
executing computational fluid dynamic (CFD) analyses of the thermocouple probe using a predetermined Reynolds number;
outputting a first temperature (T_{1CFD}) and a second temperature (T_{2CFD}) at a junction for each simulation;
applying a linear regression between the T_{1CFD} and the T_{2CFD};
outputting a slope from the linear regression; and
outputting a corrected gas temperature utilizing at least one algorithm.

19. The method of using a temperature measurement system of claim 12, wherein the at least one algorithm includes:
$${T}_{0 , corrected} = {T}_{1 , experiment} + \frac{{T}_{1 , experiment} - {T}_{2 , experiment}}{m - 1}$$

20. The method of using a temperature measurement system of claim 19, wherein the at least one algorithm includes:
$${T}_{0 corrected} = {T}_{1 , experiment} + \frac{{T}_{1 experiment} - {T}_{2 experiment}}{m - 1} + {T}_{1}^{′} + \frac{{T}_{1}^{′} - {T}_{2}^{′}}{m - 1}$$
